(19) United States
(12) Patent Application Publication
(10) Pub. No.: US 2023/0111949 A1
(43) Pub. Date: Apr. 13, 2023

(54) INTEGRATED DETECTOR ON FABRY-PEROT INTERFEROMETER SYSTEM

(71) Applicant: AMS SENSORS SINGAPORE PTE. LTD., Singapore (SG)

(72) Inventor: Javier MIGUEL SÁNCHEZ, Eindhoven (NL)

(73) Assignee: AMS SENSORS SINGAPORE PTE. LTD., Singapore (SG)

(21) Appl. No.: 17/788,273

(22) PCT Filed: Jun. 21, 2021
(86) PCT No.: PCT/SG2021/050355

§ 371 Date: Jun. 22, 2022

(30) Foreign Application Priority Data
Jun. 29, 2020 (GB) 2009903.2

(51) Int. Cl. G01J 3/02; G01J 3/26

(52) U.S. Cl. CPC G01J 3/0256; G01J 3/021; G01J 3/0229; G01J 3/26

(57) ABSTRACT

An optical sensor. The optical sensor comprises a substrate and a Fabry-Perot interferometer. The substrate is formed from a semiconductor. The Fabry-Perot interferometer comprises a first mirror and a second mirror, and is mounted on the substrate such that light is transmitted through the interferometer to the substrate. The substrate is doped such that a region of the substrate to which light is transmitted by the interferometer forms a photodiode.

### FIELD OF THE INVENTION

The present invention relates to optical components. In particular, the present invention relates to wavelength-discriminating optical sensors incorporating interferometers and photodetectors.

### BACKGROUND

Miniaturised wavelength discriminating optical sensors are often constructed with an optical interferometer mounted on a substrate, and a detector located below the substrate. For example, in the detector shown in FIG. 1, the interferometer 101 is a Fabry-Perot interferometer (also known as an etalon), which comprises a top mirror 102, a bottom mirror 103, and MEMS (micro-electro-mechanical system) elements 104 which are configured to control the spacing between the top and bottom mirrors. The interferometer is mounted on a substrate 105, and light which is transmitted by both the interferometer and the substrate is picked up by a detector 106.

There may be further optical components (e.g. lenses or optical filters) to control light entering the interferometer, or control light transmitted through the substrate. For example, lenses may be used to capture more light, or optical filters may be used to filter out unwanted light (e.g. higher order peaks of the interferometer).

This means that the sensor can only be sensitive to wavelengths that are not significantly absorbed by the substrate. Sensors can of course be made which would pick up those wavelengths (i.e. by providing an interferometer without a substrate), but these lack the stability, compactness, and ease of manufacture of the sensor shown in FIG. 1. In addition, where the substrate is a semiconductor, much of the control electronics for the interferometer can be implemented directly on the substrate (usually in a region where light is not transmitted through the interferometer).

There is a desire to provide more compact detectors, and detectors that provide the advantages of the detector of FIG. 1, but can be made sensitive to additional wavelengths of light.

### SUMMARY

According to a first aspect of the invention, there is provided an optical sensor. The optical sensor comprises a substrate and a Fabry-Perot interferometer. The substrate is formed from a semiconductor. The Fabry-Perot interferometer comprises a first mirror and a second mirror, and is mounted on the substrate such that light is transmitted through the interferometer to the substrate. The substrate is doped such that a region of the substrate to which light is transmitted by the interferometer forms a photodiode.

To allow additional detection of wavelengths not absorbed by the substrate, the optical sensor may further comprise an optical detector located on the opposite side of the substrate from the interferometer, wherein the optical detector is sensitive to wavelengths transmitted through the substrate. In this case, the photodiode may be sensitive to a first wavelength range, and the optical detector may be sensitive to a second wavelength range, and the first and second wavelength ranges may each correspond to a different mode of the interferometer.

The substrate may be doped to form an array of photodiodes, e.g. pixels. This would allow the sensor to be used in a “hyperspectral camera”.

Control electronics for the interferometer and/or the photodiode may be integrated into the substrate, allowing the entire device and controller to be implemented in a very small space. To reduce interference, the control electronics may be integrated into regions of the substrate where light passing through the interferometer does not reach.

The substrate may extend to the side of the interferometer opposite the photodiode, and support a transparent element through which light passes to the interferometer. The optical sensor may comprise one or more optical elements (e.g. a lens, filter, or mask) supported by the substrate on the side of the interferometer opposite the photodiode.

The interferometer may be an adjustable interferometer comprising MEMS components configured to adjust the spacing between the first and second mirror.

### BRIEF DESCRIPTION OF THE DRAWINGS

FIG. 1 is a schematic illustration of an optical sensor;

FIG. 2 is a schematic illustration of an exemplary optical sensor;

FIG. 3 is a schematic illustration of a further exemplary optical sensor;

FIG. 4 shows the wavelength range of the sensor of FIG. 3;

FIG. 5 shows the wavelength-dependent reflectance of a first exemplary interferometer;

FIG. 6 shows the wavelength-dependent reflectance of a second exemplary interferometer;

FIG. 7 shows example wavelengths of interest in spectroscopy.

### DETAILED DESCRIPTION

To provide a compact detector, with the advantages of the detector of FIG. 1 (as described in the description), and without the drawback of being unable to sense light which would be absorbed by the substrate, the below description proposes an improved construction of an optical sensor.

An exemplary construction is shown in FIG. 2. The optical sensor of FIG. 2 comprises an interferometer 210 disposed on a substrate 220. The interferometer 210 comprises an upper mirror 211, and a lower mirror 212, arranged to form a Fabry-Perot interferometer, such that light is transmitted through the interferometer to the substrate. The substrate 220 is a semiconductor (e.g. silicon) and comprises a doped region 221, which is doped to form a photodiode. This may be p-n doping, p-i-n doping, or any other doping to achieve a photodiode structure as known in the art. Also within the substrate 220 there may be contacts 222, which allow the signal from the photodiode to be read. This provides the robustness and ease of manufacture of a typical interferometer-on-substrate construction, but makes it more compact by removing the need for an external photodiode (or other detector), and allows the detection of wavelengths which would be absorbed by the substrate.

The spacing of the first and second mirror may be controlled by MEMS elements 213, to provide a tunable wavelength detector. The photodiode formed within the substrate will generally be sensitive to wavelengths less than the bandgap of the semiconductor.

While FIG. 2 shows a single photodiode, this is not the only option. By doping only certain regions of the substrate, an array of detectors may be formed—e.g. as pixels—allowing spatial discrimination of outputs. With suitable optics before the interferometer, this would form a “hyperspectral camera”—i.e. a camera with the ability to scan across several wavelengths, and construct an image with very deep wavelength information.

Further circuitry can be implemented within the semiconductor substrate, by semiconductor techniques as known in the art, e.g. for the control of the MEMS elements 213, or for initial processing of the outputs of the photodiode(s). This allows a very compact device to be formed, achieving “wafer level packaging” where the entire sensor (including interferometer, detector, and control circuitry) is within a single silicon (or other semiconductor) wafer.

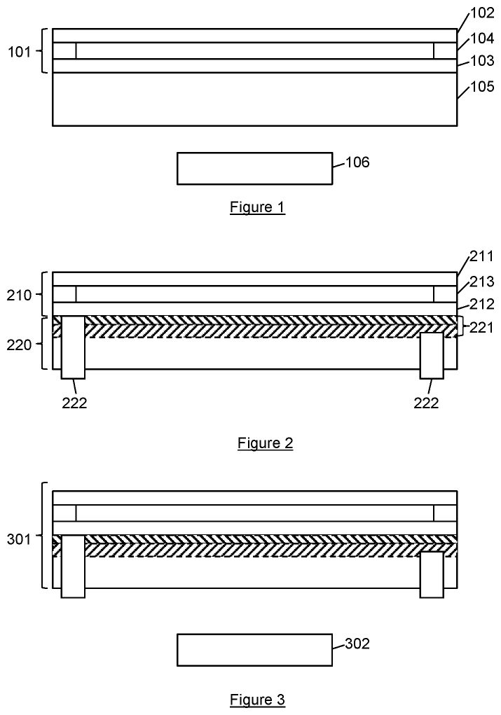

A secondary detector may be placed below the substrate, as shown in FIG. 3. The main detector 301 is equivalent to that shown in FIG. 2. The secondary detector 302 is arranged to detect light transmitted through the substrate, and is sensitive to a wavelength range which is not absorbed by the substrate. This may be a wavelength range that is adjacent to that of the main detector 301 (e.g. to provide an extended wavelength range beyond that which can be obtained using the seminconductor substrate alone). Alternatively, it may be a non-adjacent range, for example such that the main detector is sensitive to one optical mode of the interferometer, and the secondary detector is set up for another optical mode. “Optical mode of the interferometer” refers to the order 2d/λ, i.e. an interferometer with a certain distance between the mirrors will transmit a first order wavelength A (the “first mode”), a second order wavelength 2λ (“second mode”), a third order wavelength 3A (“third mode”), etc, and the detectors may be tuned such that the range of each detector encompasses a the transmission range of the interferometer in a different optical mode. Normally, a Fabry-Perot interferometer mounted on a substrate will operate in the third order or above, but the first or second order may be used if the upper and lower mirrors are metallic.

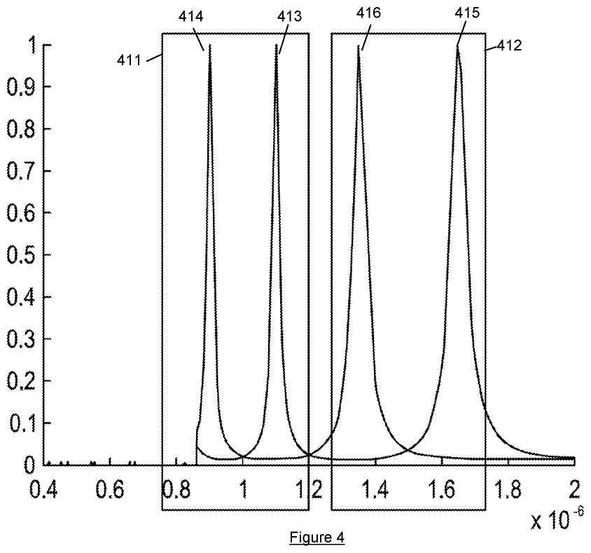

As shown in FIG. 4, the wavelength ranges for the main detector 411 and the secondary detector 412 may each correspond to different optical modes of the interferometer. In operation, the first detector detects the wavelengths transmitted by the first optical mode (maximum 413 and minimum 414 transmission peaks shown), and the second detector detects the wavelengths transmitted by the second optical mode (maximum 415 and minimum 416 transmission peaks shown).

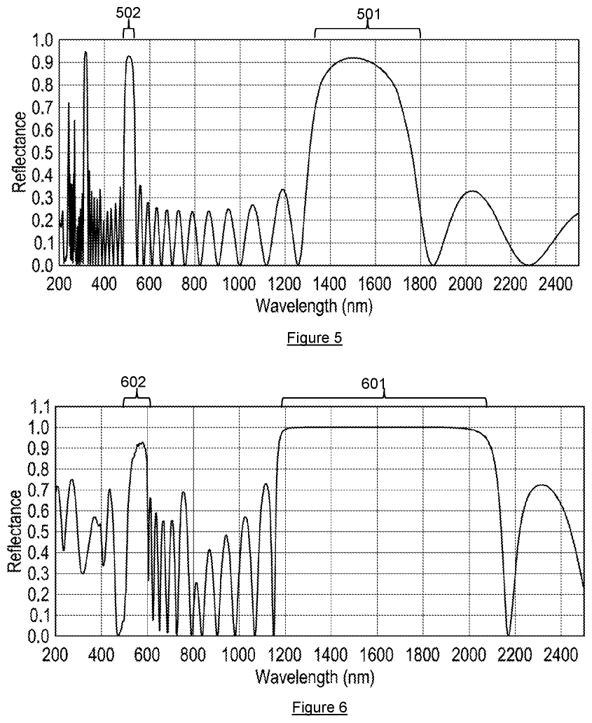

The materials of the first and second mirrors may be selected to ensure good transmission within the wavelength ranges of the first and second detectors. For example, for visible light, metal mirrors generally provide good transmission. In the near-infra red spectrum, mirrors made from alternating layers of two materials, where one material has a greater refractive index than the other, will provide good transmission. The materials may be silicon compounds. For example, FIG. 5 shows the reflectance curve for an interferometer comprising mirrors formed from alternating layers of Si₃N₄ and SiO₂, with the main usable range 501 being between 1300 and 1800 nm (corresponding to the 4th optical mode for a 400-450 nm system). By contrast, FIG. 6 shows the reflectance curve for an interferometer comprising mirrors formed from “poly-Si” and SiO₂, and the main usable range 601 is considerably larger—extending from around 1200 nm to over 2000 nm. In addition, both FIGS. 5 and 6 have a secondary usable range 502, 602 around 550 nm. When using these materials in the detector described with reference to FIG. 3, the first and second detectors may both have wavelength ranges within the main usable range, or one may have a wavelength range within the main usable range, and the other may have a wavelength range within the second usable range.

Further filters may be applied either before the interferometer, or between the interferometer and the detectors, to block light outside of the wavelength ranges of the detectors (thereby reducing interference).

Where a secondary detector is provided, the doping of the photodiode may be limited to avoid excess absorption by the photodiode within the range of the secondary detector.

While the sensor described above has many possible use cases, one particular use case is in spectroscopy. When detecting certain species in spectroscopy, each species has a characteristic set of “overtones”, i.e. harmonics of the base emission wavelength of that species. However, the relationship of the base wavelength to the overtones is not purely harmonic—several overtones may be stronger, weaker, wider, or narrower than would be expected for purely harmonic behaviour. This is shown in the example of

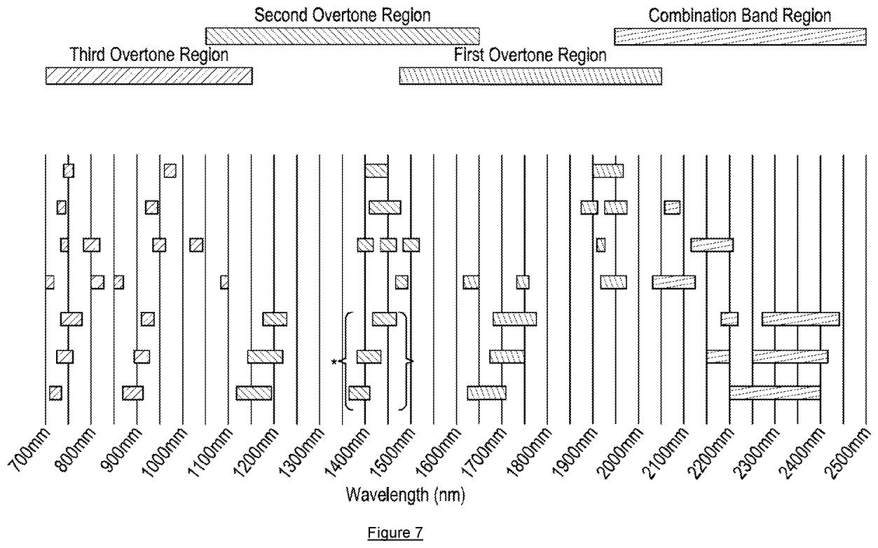

FIG. 7, for several species (each row of the chart corresponds to a species or group of closely related species). Therefore, by measuring simultaneously in corresponding wavelengths in e.g. the first and second overtone region, it is possible to get a more accurate determination of which species are present in the sample.

In general, the sensor is constructed by providing a semiconductor (e.g. silicon) substrate, forming a doped region on the substrate to form a photodiode, and providing the interferometer on face of the substrate adjacent to the photodiode. “Forming the doped region” may include diffusing dopant into the substrate, or performing an epitaxial “silicon on silicon” growth process to form the doped region directly on the substrate. “Providing the interferometer” may be done by constructing and attaching the interferometer, or where the materials of the mirrors are suitable, performing an epitaxial growth process to form the first and second mirrors, and any MEMS components. These are example construction methods only, and equivalent sensors may be manufactured in several ways.

Embodiments of the present disclosure can be employed in many different applications including spectroscopy, proximity or time of flight sensing, color measurement, etc, for example, in scientific apparatus, security, automation, food technology, and other industries.

### LIST OF REFERENCE NUMERALS

101 Interferometer
102 Top mirror
103 Bottom mirror
104 MEMS elements
105 Substrate
106 Detector
210 Interferometer
211 Upper mirror
212 Lower mirror
213 MEMS elements
220 Substrate
221 Doped region/photodiode
222 Contacts
301 Main detector
302 Secondary detector
411 Wavelength range of first detector
412 Wavelength range of second detector
413 Maximum transmission peak of first mode
414 Minimum transmission peak of first mode
415 Maximum transmission peak of second mode
416 Minimum transmission peak of second mode
501 Main usable range of interferometer
502 Secondary usable range of interferometer
601 Main usable range of interferometer
602 Secondary usable range of interferometer

The skilled person will understand that in the preceding description and appended claims, positional terms such as ‘above’, ‘along’, ‘side’, etc. are made with reference to conceptual illustrations, such as those shown in the appended drawings. These terms are used for ease of reference but are not intended to be of limiting nature. These terms are therefore to be understood as referring to an object when in an orientation as shown in the accompanying drawings.

Although the disclosure has been described in terms of preferred embodiments as set forth above, it should be understood that these embodiments are illustrative only and that the claims are not limited to those embodiments. Those skilled in the art will be able to make modifications and alternatives in view of the disclosure which are contemplated as falling within the scope of the appended claims. Each feature disclosed or illustrated in the present specification may be incorporated in any embodiments, whether alone or in any appropriate combination with any other feature disclosed or illustrated herein.

1. An optical sensor comprising:
a substrate (220) formed from a semiconductor; and
a Fabry-Perot interferometer (210) comprising a first mirror (211) and a second mirror (212), and disposed on the substrate such that light is transmitted through the interferometer to the substrate;
wherein the substrate is doped such that a region (221) of the substrate to which light is transmitted by the interferometer forms a photodiode.

2. An optical sensor according to claim 1, and comprising an optical detector located on the opposite side of the substrate from the interferometer, wherein the optical detector is sensitive to wavelengths transmitted through the substrate.

3. An optical sensor according to claim 2, wherein the photodiode is sensitive to a first wavelength range, and the optical detector is sensitive to a second wavelength range, and wherein the first and second wavelength ranges each correspond to a different mode of the interferometer.

4. An optical sensor according to claim 1, wherein the substrate is doped to form an array of photodiodes.

5. An optical sensor according to claim 1, wherein control electronics for the interferometer and/or the photodiode are integrated into the substrate.

6. An optical sensor according to claim 5, wherein the control electronics are integrated into regions of the substrate where light passing through the interferometer does not reach.

7. An optical sensor according to claim 1, wherein the substrate extends to the side of the interferometer opposite the photodiode, and supports a transparent element through which light passes to the interferometer.

8. An optical sensor according to claim 7, and comprising one or more optical elements supported by the substrate on the side of the interferometer opposite the photodiode.

9. An optical sensor according to claim 8, wherein the optical elements include any one or more of:
a lens;
a filter; and
a mask.

10. An optical sensor according to claim 1, wherein the interferometer is an adjustable interferometer comprising MEMS components configured to adjust the spacing between the first and second mirror.

11. A method of manufacturing an optical sensor, the method comprising:
providing a substrate formed from a semiconductor;
doping a region of the substrate to form a photodiode, the region including an upper face of the substrate; and
disposing an interferometer in the upper face, the interferometer comprising a first mirror and a second mirror.

12. A method according to claim 11, and comprising connecting electrical contacts to the photodiode by one of:
etching into the substrate from the upper face, and applying electrical contacts to the photodiode through the etched regions; or
forming a plurality of vias though the substrate, and applying electrical contacts to the photodiode through each via.

13. A method according to claim 11, wherein disposing the interferometer on the upper face comprises forming the first and second mirrors via an epitaxial growth process.

14. A method according to claim 13, and comprising forming MEMS components configured to adjust the spacing between the first and second mirror via an epitaxial growth process.

15. A method according to claim 11, wherein doping a region of silicon to form the photodiode comprises growing the doped region via an epitaxial growth process.
